(19) United States
(12) Patent Application Publication
(10) Pub. No.: US 2018/0121897 A1
(43) Pub. Date: May 3, 2018

(54) RETAIL STORE SCANNING GAME AND PURCHASE SYSTEM

(71) Applicant: Wal-Mart Stores, Inc., Bentonville, AR (US)

(72) Inventors: Yurgis Mauro Bacallao, Centerton, AR (US); Paul Buckley, Rogers, AR (US); Douglas Jahe Ryner, Cave Springs, AR (US); Todd Mattingly, Bentonville, AR (US)

(21) Appl. No.: 15/789,383

(22) Filed: Oct. 20, 2017

Related U.S. Application Data
(60) Provisional application No. 62/413,599, filed on Oct. 27, 2016.

(51) Int. Cl. G06Q 20/18; G06Q 30/06

(52) U.S. Cl. CPC G06Q 20/18; G06Q 30/0601

(57) ABSTRACT

Described is a retail store electronic scanning game and purchase system that includes electronic scan devices for both children and parents. The device used by the parent can electronically purchase items through the retail store purchase utility. The child's electronic scan device is made a slave device to the parent's device by subserviently coupling the child's device to the parent's device. All purchasing and gaming communications from the slave device are routed through the parent device for approval. The parent can give the children shopping tasks such as finding products for purchase and scanning them. The child can participate in shopping games with the slave electronic scan devices. The parent can award game points to the children, and approve or reject purchases presented by the children. The children can have fun and participate in shopping tasks, with the parent overseeing all game and shopping activities of the children.

### CROSS REFERENCE TO RELATED APPLICATION

This invention claims priority to U.S. provisional patent application Ser. No. 62/413,599, filed Oct. 27, 2016 to Applicant Wal-Mart Stores Inc., and entitled “Retail Store Scanning Game and Purchase System”, which is incorporated entirely herein by reference.

### BACKGROUND OF THE INVENTION

### Technical Field

This invention relates to electronic purchasing within a retail store, and specifically to an electronic scanning game and purchase system, which allows parents to provide scanners to their children for scanning products to be purchased and to play shopping games, while keeping product purchases controlled by a scanning device carried by the parent.

### State of the Art

Customers shopping in some retail stores have the capability to electronically scan and purchase their products themselves, instead of relying on a store clerk to scan and ring up purchases. Stores may provide electronic scanners for customers to carry to scan items they wish to purchase while they shop. This relieves the customer of having to go through a checkout counter when done shopping. It would be useful for parents to be able to provide scanners for their children to use to keep them occupied and allow the children to be useful, but it would be dangerous for kids to have uncontrolled use of an electronic purchase scanner. The children could purchase items the parent did not want and cause issues for the parent and the store if the children's use of the scanner was not controlled.

Accordingly, what is needed is a system for electronic purchase in a retail store that allows children to be a part of the shopping experience, but not have purchase control. It is also desirable if children can participate in games while shopping to keep them occupied and give them rewards for productive shopping behavior.

### BRIEF DESCRIPTION OF THE DRAWINGS

FIG. 1 shows a simplified representation of a retail store electronic scanning game and purchase system;

FIG. 2 shows a simplified block diagram of the retail store electronic scanning game and purchase system of FIG. 1;

FIG. 3 shows a simplified illustration of a first electronic scanning device scanning a linking symbol on a second electronic scanning device;

FIG. 4 illustrates a simplified block diagram showing a first electronic scan device controlling the purchase of a product scanned by a second electronic scan device;

FIG. 5 illustrates a method of purchasing a product;

FIG. 6 illustrates a further method of purchasing a product; and

FIG. 7 illustrates a method of electronically submitting a purchase request using an electronic scan device.

### DETAILED DESCRIPTION OF EMBODIMENTS OF THE INVENTION

As discussed above, embodiments of the present invention relate to electronic purchasing within a retail store, and specifically to an electronic scanning game and purchase system which allows parents to provide scanners to their children for scanning products to be purchased and to play shopping games, while keeping product purchases controlled by a scanning device carried by the parent.

Taking children shopping can be difficult for both parents and children. The parent is trying to accomplish the task of purchasing needed items. The children may get bored and often get in trouble trying to find something to do while their parent shops. Often the children wish to have a productive role in their parent's shopping. Sometimes they wish to play a game to keep them busy while their parent shops. The disclosed retail store electronic scanning game and purchase system includes electronic scan devices for both children and parents. The children can use their electronic scan devices to scan products to be purchased by the parents and earn points in electronic games played with the electronic scan device. The parent uses their electronic scan device to control the purchasing and gaming activities of the children. The parent uses their electronic scanning device to approve or deny purchases attempted by the children, to issue game points to the children for good shopping behavior, and to provide shopping tasks for the children to perform. This keeps the children occupied and productive, and rewards good shopping behaviors, and allows the parent to get shopping completed faster when shopping tasks are shared with the children.

The disclosed electronic scanning game and purchase system includes a retail store purchase utility and a retail store gaming utility, each provided by the retail store. These are often resident on a server inside the retail store or a retail store building. The electronic scanning game and purchase system also includes a first electronic device carried by the parent. The first electronic scan device becomes a master electronic scan device. The first electronic scan device is communicatively coupled to the retail store purchase utility, and is used to scan and purchase products while in the retail store. The first electronic scan device can be an electronic scan device loaned to the parent by the store, or brought into the store by the parent, such as a smart phone, tablet, or other portable computing device. The first electronic scan device can be any portable electronic device capable of capturing a scan code for the purpose of purchasing a product, and capable of communicating with the retail store purchase utility to purchase the product. The retail store purchase utility accepts purchase requests for products from the first electronic scan device.

The disclosed electronic scanning game and purchase system also includes a second electronic scan device carried by a child or other individual. The second electronic scan device can be an electronic scan device loaned to the child by the store, or brought into the store by the child. The second electronic scan device can be a smart phone, a tablet, or any other portable computing device capable of capturing a scan code and communicating with the first electronic scan device. The second electronic scan device is programmed to be a slave electronic scan device as described herein. The second electronic scan device is programmed to be a slave device by having the first electronic scan device scan a linking symbol on a display of the second electronic scan device, for example. A scan by the first electronic scan device of the linking symbol on the display of the second electronic scan device makes the second electronic scan device a slave to the first electronic scan device, and disables access of the second electronic scan device to the retail store purchase utility. Once the second electronic scan device becomes a slave device to the first electronic scan device, the second electronic scan device is communicatively coupled to the first electronic scan device, but is prevented (disabled) from executing purchases with the retail store purchase utility. All purchasing and gaming communications from the second electronic scanning device are accepted by the first electronic scan device instead of by the retail store purchase utility. There can be any number of additional slave devices for additional children. Once the second and additional slave electronic scan devices are subserviently coupled to the first electronic scan device, the first electronic scan device controls the purchases and gaming of the second and additional electronic scan devices. The parent can give the children shopping tasks such as finding products for purchase and scanning them. The child can participate in shopping games with the slave electronic scan devices. The parent can award game points to the children, and approve or reject purchases presented by the children. The children can have fun and participate in shopping tasks, with the parent overseeing all game and shopping activities of the children.

It is to be understood that the system described herein is described as used by a parent and children, but individuals of any type and relationship can use the system, with one electronic scan device being the master device and carried by one individual, and one or more other electronic scan devices being the slave devices and carried by one or more other individuals. It is also to be understood that the first, second, and additional electronic scan devices are not inherently master or slave devices. The devices may be identical and are not set up to be master or slave devices until linking symbols are scanned. Instead, the devices are brought into the store by the parents and children, or picked up inside the store for their use by the parents and children, and become master or slave devices by subserviently coupling the devices by scanning a linking symbol on one of the devices with another device. If the electronic scan devices are brought into the store by the users, they may need to download an app that allows the subservient coupling. If the store dispenses the electronic scan devices, the capability for subservient coupling will be provided by the retail store.

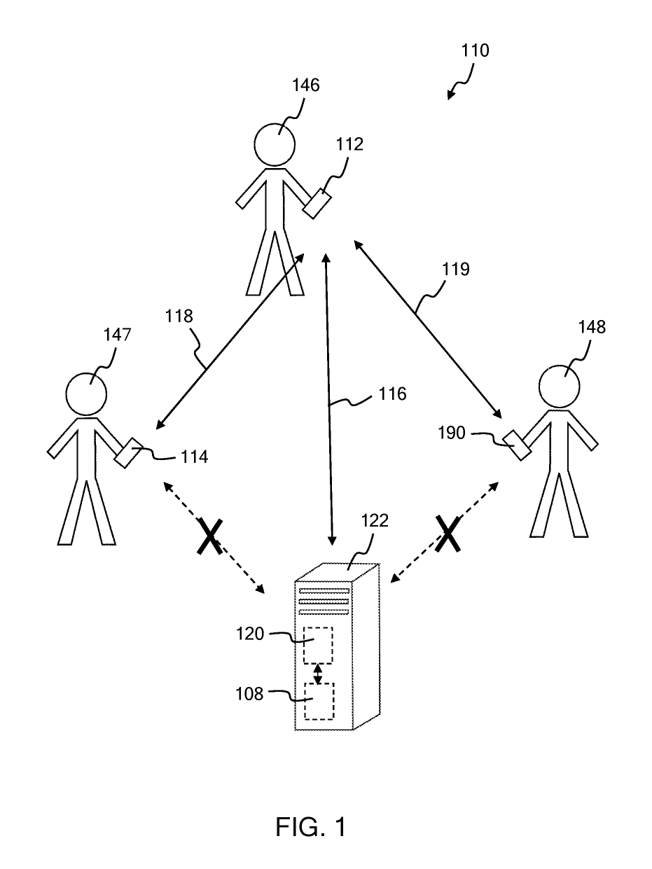

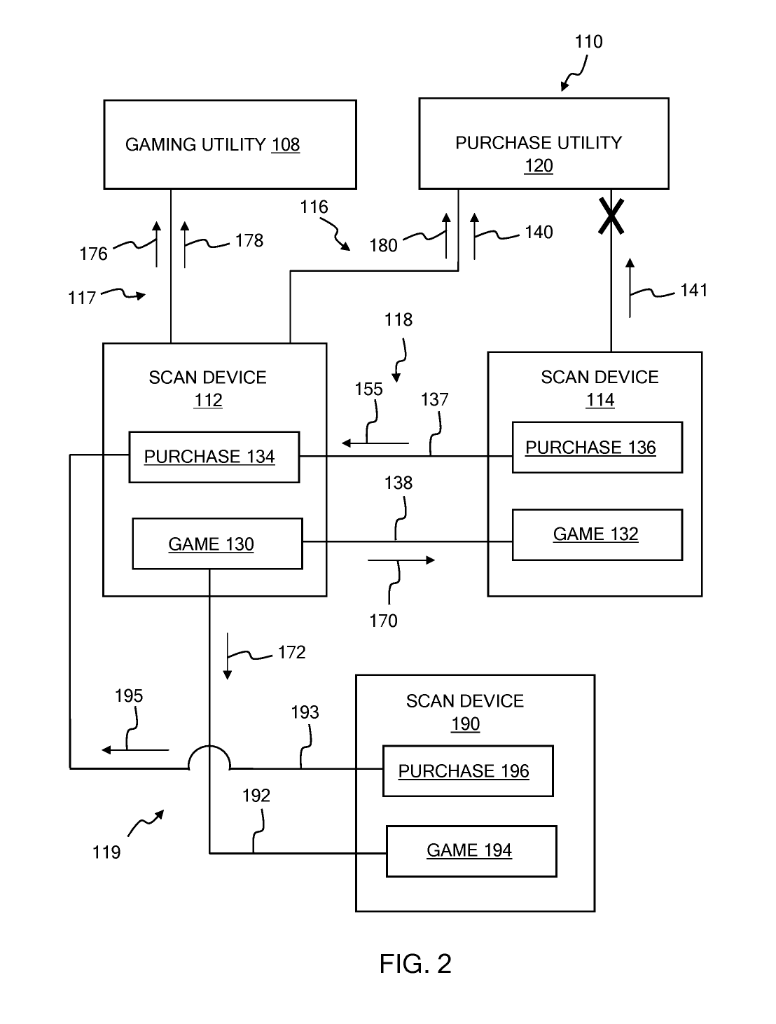

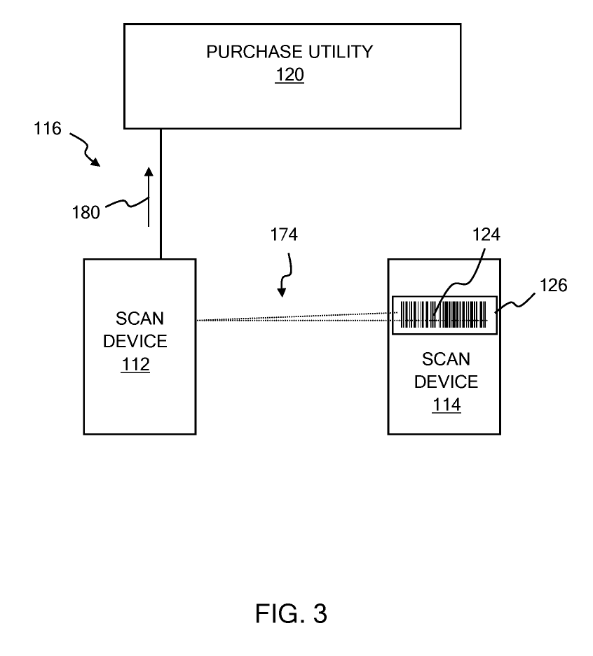

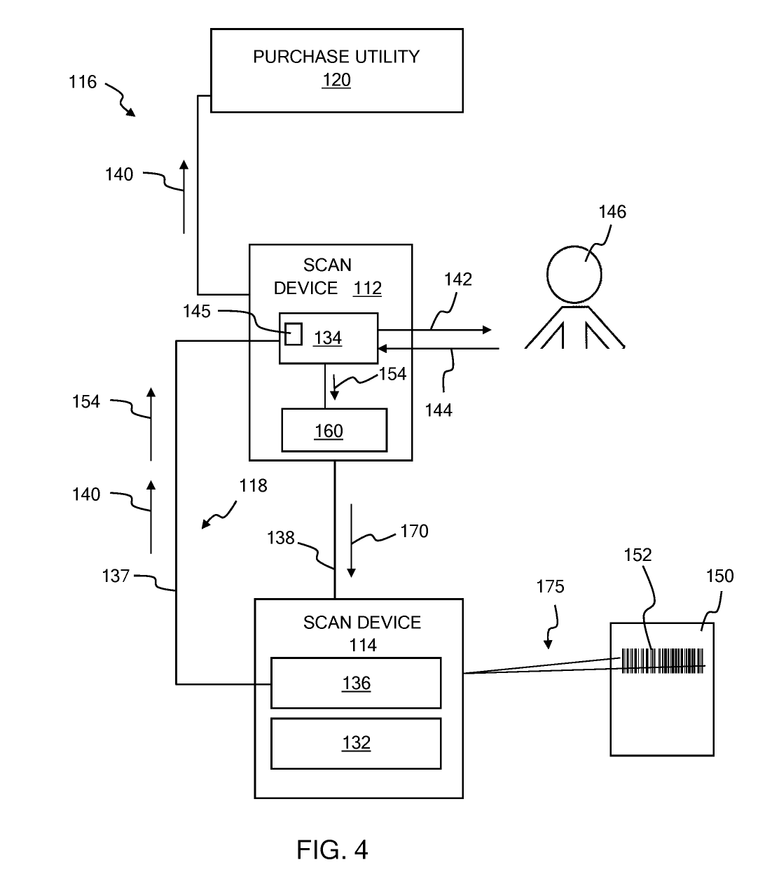

FIG. 1 through FIG. 4 shows a simplified representation of a retail store scanning game and purchase system 110. FIG. 1 shows a simplified illustration of retail store scanning game and purchase system 110. FIG. 2 shows a simplified block diagram of retail store scanning game and purchase system 110. FIG. 3 illustrates a simple block diagram of a second electronic scan device 114 being subserviently coupled to a first electronic scan device 112, and first electronic scan device 112 communicatively coupled to a purchase utility 120. FIG. 4 illustrates a simplified block diagram of first electronic scan device 112 approving and executing a purchase of a product 150 scanned by second electronic scan device 114.

Retail store scanning game and purchase system 110 includes retail store purchase utility 120 and a retail store gaming utility 108. In this embodiment, retail store purchase utility 120 and retail store gaming utility 108 are each resident on a server 122 in a retail store, see FIG. 1. In some embodiments, retail store purchase utility 120 and retail store gaming utility 108 are resident on a remote server or a cloud server. Retail store purchase utility 120 executes electronic purchases of products for the retail store. Retail store purchase utility 120 can be any software, hardware, firmware, or combination device that can be communicatively coupled to electronic scan devices and used to electronically purchase products for the retail store.

Retail store gaming utility 108 is communicatively coupled to electronic scan devices to execute electronic gaming with the electronic scan device. Retail store gaming utility 108 can be any software, hardware, firmware, or combination device that can be communicatively coupled to electronic scan devices and used to electronically execute games for the retail store.

Retail store scanning game and purchase system 110 includes first electronic scan device 112, and one or more additional electronic scan devices, which, in the embodiment shown in the figures, includes second electronic scan device 114 and a third electronic scan device 190, see FIG. 1 and FIG. 2. In some embodiments, system 110 includes only first electronic scan device 112 and second electronic scan device 114. In some embodiments, system 110 includes more than three electronic scan devices.

One of the electronic scan devices is made the master electronic scan device, and is carried by the parent or other governing individual. In the embodiment shown in the figures, user 146 is the parent or guardian and carries first electronic scan device 112. First electronic scan device 112 is communicatively coupled to retail store purchase utility 120 via a communication link 116 (FIG. 2) in this embodiment. First electronic scan device 112 is communicatively coupled to retail store gaming utility 108 using a communication link 117 (FIG. 2) in this embodiment. Retail store purchase utility 120 accepts purchase requests for purchases of products from first electronic scan device 112.

Retail store purchase utility 120 in this embodiment is a software controlled system resident on store server 122, in this embodiment. Store server 122 also includes retail store gaming utility 108, which is a software controlled system that provides and governs retail store games that customers can participate in. Store server 122 is resident in the retail store that user 146 is shopping in, in this embodiment, but it is to be understood that store server 122 can be in any physical or virtual location including a remote building, a cloud server, or any internet or wired or wireless communication-accessed device. In some embodiments, retail store purchase utility 120 and/or retail store gaming utility 108 are hardware controlled devices. Retail store purchase utility 120 and retail store gaming utility 108 can be any combination of hardware, firmware, or software.

Users 147 and 148, in this embodiment, are children of user 146. User 147 carries second electronic scan device 114, and user 148 carries third electronic scan device 190. First electronic scan device 112 becomes a master over second and third electronic scan devices 114 and 190, and second and third electronic scan device 114 and 190 are made slave devices to first electronic scan device 112, by subserviently coupling second and third electronic scan device 114 and 190 to first electronic scan device 112, as illustrated in FIG. 3. Subserviently coupling means coupling second electronic scan device 114 to first electronic scan device 112 such that first electronic scan device 112 becomes a master device and second electronic scan device 114 is a slave device to first electronic scan device 112. The master device (first electronic scan device 112) controls purchasing and gaming activities of the slave device (second electronic scan device 114), and second electronic scan device 114 is no longer allowed to purchase items through retail store purchase utility 120.

FIG. 3 shows second electronic scan device 114 being subserviently coupled to first electronic scan device 112. Second electronic scan device 114 is made to display a linking symbol 124 on a display 126 of second electronic scan device 114. First electronic scan device 112 performs an optical scan 174 of linking symbol 124, which subserviently couples second electronic scan device 114 to first electronic scan device 112. Thus, subservient coupling, in this embodiment, is accomplished by first electronic scan device 112 scanning a linking symbol 124 of second electronic scan device 114. Optical scan 174 can be accomplished by any means, including a laser scanner, a camera scan, an optical capture, or any other means of capturing a linking symbol 124. Linking symbol 124 is a bar code in this embodiment, but can be a QR code, an image, a symbol, an alphanumeric character, or any other symbol that can be displayed on display 126 and captured by optical scan 174. Linking symbol 124 is displayed on display 126 in this embodiment, but this is not meant to be limiting. In some embodiments, linking symbol 124 is printed on or attached to second electronic scan device 114 instead of being electronically displayed on display 126. Second electronic scan device 112 and third electronic scan device 190 are communicatively coupled to first electronic scan device 112 using communication links 118 and 119, respectively. Scan 174 by first electronic scan device 112 of linking symbol 124 on display 126 of second electronic scan device 114 disables access of second electronic scan device 114 to retail store purchase utility 120, and communicatively couples second electronic scan device 114 to first electronic scan device 112.

Similarly, third electronic scan device 190 is subserviently coupled to first electronic scan device 112 by first electronic scan device 112 scanning a linking symbol on a display of third electronic scan device 190. Third electronic scan device 190 is disabled from accessing retail store purchase utility 120, and is communicatively coupled to first electronic scan device 112 by first electronic scan device 112 scanning the linking symbol on a display of third electronic scan device 190.

Subservient coupling can be accomplished in numerous ways. In some embodiments, second electronic scan device 114 is subserviently coupled to first electronic scan device 112 by second electronic scan device 114 scanning a linking symbol displayed on a display of first electronic scan device 112. In some embodiments, second electronic scan device 114 is subserviently coupled to first electronic scan device 112 with a two-step process, the first step being first electronic scan device 112 scanning linking symbol 124 of display 126 of second electronic scan device 114, and the second step being second electronic scan device 114 scanning a linking symbol displayed on a display of first electronic scan device 112. In some embodiments, subservient coupling is accomplished in other ways.

Returning to the embodiment shown in FIG. 1 through FIG. 4, second electronic scan device 114 is subserviently coupled to first electronic scan device 112 by first electronic scan device 112 scanning linking symbol 124 on display 126 of second electronic scan device 114, as shown in FIG. 3. Third electronic scan device 190 is subserviently coupled to first electronic scan device 112 by first electronic scan device 112 scanning a linking symbol on a display of third electronic device 190. The subservient coupling can be performed at the beginning of the shopping trip, for example. In the embodiment shown in the figures, users 146, 147, and 148 enter the retail store, and user 146 gathers first, second, and third electronic scan devices 112, 114, and 190 from the loaner inventory of electronic scan devices provided by the retail store. User 146 makes second and third electronic scan devices 114 and 190 to display a linking symbol on their display, and uses first electronic scan device 112 to scan the linking symbol on each of first and second electronic scan device 114 and 190. This subserviently couples second and third electronic scan devices 114 and 190 to first electronic scan device 112 and disables access of second electronic scan device 114 and third electronic scan device 190 to retail store purchase utility 120.

Once second electronic scan device 114 is subserviently coupled to first electronic scan device 112, first electronic scan device 112 sends a second electronic scan device notice of subservient status 180 to purchase utility 120, as shown in FIG. 2 and FIG. 3. This tells purchase utility 120 that second electronic scan device 114 is subservient to first electronic scan device 112, and that purchase utility 120 should disable access to retail store purchase utility 120 for second electronic scan device 114, in other words, that purchase utility 120 should not execute any purchase requests received from second electronic scan device 114. Second electronic scan device 114 is prevented from executing purchases through retail store purchase utility 120 in response to first electronic scan device 112 sending second electronic scan device notice of subservient status 180 to purchase utility 120. Thus, second electronic scan device 114 is prevented from executing purchases through retail store purchase utility 120 in response to first electronic scan device 112 scanning linking symbol 124 on display 126 of second electronic scan device 114.

Similarly, once third electronic scan device 190 is subserviently coupled to first electronic scan device 112, first electronic scan device 112 sends a third electronic scan device notice of subservient status to purchase utility 120. This tells purchase utility 120 that third electronic scan device 190 is subservient to first electronic scan device 112, and that purchase utility 120 should not execute any purchase requests received from third electronic scan device 190. Third electronic scan device 190 is prevented from executing purchases through retail store purchase utility 120 in response to first electronic device 112 sending the third electronic scan device notice of subservient status to purchase utility 120. Thus, third electronic scan device 190 is prevented from executing purchases through retail store purchase utility 120 in response to first electronic scan device 112 scanning a linking symbol on a display of third electronic scan device 190.

Referring back to FIG. 1 and FIG. 2, first electronic scan device 112 is communicatively coupled via communication link 116 and 117 to purchase utility 120 and gaming utility 108 on server 122. Communication links 116 and 117 can be wired or wireless, electrical, optical, or any other form of communication link. Once second and third electronic scan device 114 and 190 are subserviently coupled to first electronic scan device 112, second and third electronic scan device 114 are disabled from purchase and gaming communications with server 122. Instead, second electronic scan device 114 is communicatively coupled to first electronic scan device 112 with communication link 118, and third electronic scan device 190 is communicatively coupled to first electronic scan device 112 with communication link 119. Communication links 118 and 119 can be wired or wireless and use any method of communication.

User 146 can now give second and third electronic scan devices 114 and 190 to the children, users 147 and 148. Users 147 and 148 can participate in purchase activity and gaming activity of retail store electronic scanning game and purchase system 110 through first electronic scan device 112. User 146, the parent or guardian, does not have to be concerned that users 147 and 148 will electronically purchase unwanted items or cause other problems through direct interaction with purchase utility 120 and/or gaming utility 108. User 146 is the master device controlling the slave devices, and receives and controls the communications from second and third electronic scan devices 114 and 190.

Second electronic device communication link 118 includes both a second electronic device purchase communication 137 and a second electronic device game communication 138, as shown in FIG. 2 and FIG. 4. Second electronic scan device 114 exchanges second electronic device purchase communications 137 with first electronic scan device 112. And second electronic scan device 114 exchanges second electronic device gaming communications 138 with first electronic scan device 112, as shown in FIG. 2 and FIG. 4. First electronic scan device 112 includes a game module 130 and a purchase module 134. Second electronic scan device 114 includes a game module 132 and a purchase module 136. Second electronic scan device purchase communication 137 communicatively couples purchase modules 134 and 136. Second electronic scan device gaming communication 138 communicatively couples gaming modules 130 and 132. Second electronic scan device 114 exchanges second electronic device gaming communications 138 with first electronic scan device 112 in response to subserviently coupling second electronic scan device 114 to first electronic scan device 112. In the embodiment shown in the figures, subserviently coupling second electronic scan device 114 to first electronic scan device 112 is accomplished by first electronic scan device 112 scanning linking symbol 124 on display 126 of second electronic scan device 114, as shown in FIG. 3.

Similarly, third electronic device communication link 119 includes both a third electronic device purchase communication 193 and a third electronic device game communication 192. Third electronic scan device 190 exchanges third electronic device purchase communications 193 with first electronic scan device 112. And third electronic scan device 190 exchanges third electronic device gaming communications 192 with first electronic scan device 112, as shown in FIG. 2. Third electronic scan device 190 includes a game module 194 and a purchase module 196. Third electronic scan device purchase communication 193 communicatively couples purchase modules 134 and 196. Third electronic scan device gaming communication 192 communicatively couples gaming modules 130 and 194. Third electronic scan device 190 exchanges third electronic device gaming communications 192 with first electronic scan device 112 in response to subserviently coupling third electronic scan device 190 to first electronic scan device 112. In the embodiment shown in the figures, subserviently coupling third electronic scan device 190 to first electronic scan device 112 is accomplished by first electronic scan device 112 scanning a linking symbol on a display of third electronic scan device 190.

Once second and third electronic scan devices 114 and 190 are subserviently coupled to first electronic scan device 112, user 147 and 148 can participate in purchase and gaming activities only by going through first electronic scan device 112. Purchase utility 120 will not accept purchase requests from second and third electronic scan devices 114 and 190, and gaming utility 108 will not accept gaming communication from second and third electronic scan devices 114 and 190. Second and third electronic scan devices 114 and 190 are disabled from access to retail store purchase utility 120 and retail store gaming utility 108. User 146 gives second and third electronic scan devices 114 and 190 to users 147 and 148, with purchase and gaming instructions. The games may be amusement games, or they may be shopping games set up to help user 146 complete their shopping.

For example, users 146 can give user 147 and 148 a shopping list 145 (FIG. 4), and each user 147 and 148 can earn a game point or a game reward for each item on shopping list 145 that either user 147 or 148 finds and scans with their electronic scan device 114 or 190. Shopping list 145 is stored in first electronic scan device purchase utility 134, as shown in FIG. 4. User 146 uses first electronic scan device 112 to award the game point or reward to user 147 or 148. User 147 goes off shopping on their own with shopping list 145, and finds and scans products with second electronic scan device 114. Second electronic scan device 114 transmits a plurality of first captured product scan codes 155 to first electronic scan device 112, where the plurality of first captured product scan codes 155 represents the products user 147 has found and scanned with second electronic scan device 114. User 146 reviews plurality of first captured product scan codes 155, approves or denies the purchase of each individual product, and uses first electronic scan device 112 to award a second electronic scan device game point 170 for each one of plurality of first captured product scan codes 155 that user 146 approves for purchase. Approved products are purchased by user 146 using first electronic scan device 112, and denied products are returned to the shelf and not purchased. This allows user 147 to participate in shopping and obtain game points for good shopping behaviors. Purchases are approved if the products are on shopping list 145. Purchases can be denied for any number of reasons, including that the product is not on shopping list 145, or the product is a restricted product such as alcohol or tobacco. User 146 can program first electronic scan device 112 to approve or deny purchase of products for any number of reasons, and can make lists of products to approve or products to deny.

Similarly, third electronic scan device 190 is used by user 148 to participate in the shopping trip. Third electronic scan device 190 transmits a plurality of second captured product scan codes 195 to first electronic scan device 112 (FIG. 2). User 146 approves or denies the purchase of each one of the items included in plurality of second captured product scan codes 195. First electronic scan device 112 awards a third electronic device game point 172 to third electronic scan device 190 for each of plurality of second captured product scans 195 that are approved for purchase by user 146 of first electronic scan device 112.

First electronic scan device 112, specifically game module 130, tracks a total number of second electronic device game points 176 awarded to second electronic scan device 114, and a total number of third electronic scan device game points 178 awarded to third electronic scan device 190. First electronic scan device 112 sends total number of second electronic device game points 176 and total number of third electronic scan device game points 178 to retail store gaming utility 108, as shown in FIG. 2. Retail store gaming utility 108 can use total number of second electronic device game points 176 and total number of third electronic scan device game points 178, and numbers of total game points awarded to other users, to keep track of, and report, high scores, for examples, or to give loyalty points for game points, as another example. Gaming utility 108 can post high scores in the retail store, for example, so that users 147 and 148 can compete against other users and try to get the high score.

Gaming utility 108 and first electronic scan device 112 can provide many different types of games for users 147 and 148 to participate in. Some games can be for amusement or education, and not be related to the shopping trip. Some games can include shopping participation. For example, game modules 132 and 194 can be programmed to provide educational information for each scan code that electronic scan device 114 or 190 captures a scan of. Users 147 and 148 will be more interested in shopping and more engaged when they can use first and second electronic scan devices 114 and 190 in various game and purchase tasks.

FIG. 4 illustrates a purchase executed by first electronic scan device 112 of a product 150 that has been scanned by second electronic scan device 114. User 147 finds product 150 (which is on shopping list 145 provided by user 146, in this example), and performs an optical scan 175 on product scan code 152 on product 150. Second electronic scan device 114 cannot purchase this product directly through purchase utility 120, because second electronic scan device 114 has been made subservient to first electronic scan device 112, and its access to retail store purchase utility 120 has been disabled. If second electronic scan device 114 sends an electronic purchase request 141 to purchase utility 120 in an attempt to purchase product 150, this request is denied by purchase utility 120, as shown in FIG. 2. Instead, the purchase of product 150 needs to go through first electronic scan device 112, as shown in FIG. 4.

Second electronic scan device 114 captures a captured product scan code 154 representing product 150 by performing optical scan 175 on product scan code 152 of product 150. Second electronic scan device 114 sends captured product scan code 154 representing product 150, and purchase request 140 for product 150, to first electronic scan device 112 in response to second electronic scan device 114 scanning product scan code 152 of product 150. In the embodiment shown in FIG. 4, captured product scan code 154 and purchase request 140 originate from purchase module 136 and are delivered to purchase module 134. Purchase module 134 of first electronic scan device 112 receives captured product scan code 154 and purchase request 140 and requests a purchase approval indicator of product 150 from user 146 in response. Purchase module 134 sends a purchase approval request 142 to user 146, as shown in FIG. 4. Purchase approval request 142 can be a message displayed on a display of first electronic scan device 112, or a verbal message delivered by phone, or any other request for input.

User 146 receives purchase approval request 142 and either approves or denies the purchase of product 150. If the purchase of product 150 is denied by user 146, second electronic scan device 114 instructs user 147 to return product 150 to the shelves and the purchase is not executed. If user 146 approves of the purchase of product 150, user 146 enters a purchase approval indicator 144 for product 150. Purchase approval indicator 144 can be entered for product 150 by hitting a button on first electronic scan device 112, touching an icon, or any other way of having user 146 tell first electronic scan device 112 that user 146 approves of the purchase of product 150. First electronic scan device 112 purchases product 150 using purchase utility 120 in response to receiving purchase approval indicator 144.

In the embodiment shown in FIG. 4, first electronic scan device 112 purchases product 150 by sending electronic purchase request 140 for product 150 to purchase utility 120. Purchase utility 120 exchanges communications 116 with first electronic device 112 to complete the purchase of product 150, and, once the purchase is complete, purchase utility 120 instructs user 146 that product 150 can be bagged and removed from the retail store. In this embodiment, first electronic scan device 112 transmits purchase request 140 for product 150 to retail store purchase utility 120 in response to receiving electronic purchase request 140 for product 150 from second electronic scan device 114, and receiving purchase approval indicator 144 for product 150 from user 146 of first electronic scan device 112.

In some embodiments, first electronic scan device can approve or deny purchases based on whether products are on approved or denied lists instead of input from user 146. For example, in some embodiments, first electronic scan device 112 transmits purchase request 140 for product 150 to retail store purchase utility 120 in response to receiving electronic purchase request 140 for product 150 from second electronic scan device 114, and verifying that product 150 is listed on shopping list 145 stored in first electronic scan device 120. If second electronic scan device 114 scans a second product and sends a second electronic purchase request to first electronic scan device 112, but the second product is not listed on shopping list 145, first electronic scan device 112 will deny the purchase of the second product. In this embodiment, first electronic scan device 112 rejects a second electronic purchase request for a second product from the second electronic scan device because the second product is not listed on shopping list 145 stored in first electronic scan device 112.

Similarly, a list of restricted products can be stored in first electronic scan device 112. In some embodiments, first electronic scan device 112 rejects a second electronic purchase request for a second product from the second electronic scan device because the second product is listed on a restricted product list stored in first electronic scan device 112. In some embodiments, the product scan code will indicate that the product is a restricted product such as alcohol or tobacco, and first electronic scan device 112 will reject any purchase requests for restricted products.

In some embodiments, first electronic scan device 112 adds captured scan code 154 representing product 150 to an electronic shopping cart of first electronic scan device 112 in response to first electronic scan device 112 receiving purchase approval indicator 144. When shopping is complete, first electronic scan device 112 will purchase all of the items in the electronic shopping cart through purchase utility 120. This saves first electronic scan device 112 from having to purchase each item individually.

First electronic scan device 112 awards second electronic device game point 170 to second electronic scan device 114 in response to first electronic scan device 112 receiving purchase approval indicator 144. The games can be designed, for example, to reward productive shopping behavior. Points can be awarded for products found and scanned by a child that are eventually purchased. In some embodiments, points are subtracted for products scanned by the child but are rejected for purchase. This may minimize the number of extraneous and/or unwanted product scans that a parent receives for approval. Games can be designed both to reward productive shopping behavior, to educate and/or amuse the child, and keep them busy and happy during shopping trips. In this way, retail store electronic scanning game and purchase system 110 provides a way for children to help their parents complete shopping, and to keep the children busy and having fun during shopping trips so the parents and the children can have a more enjoyable shopping experience.

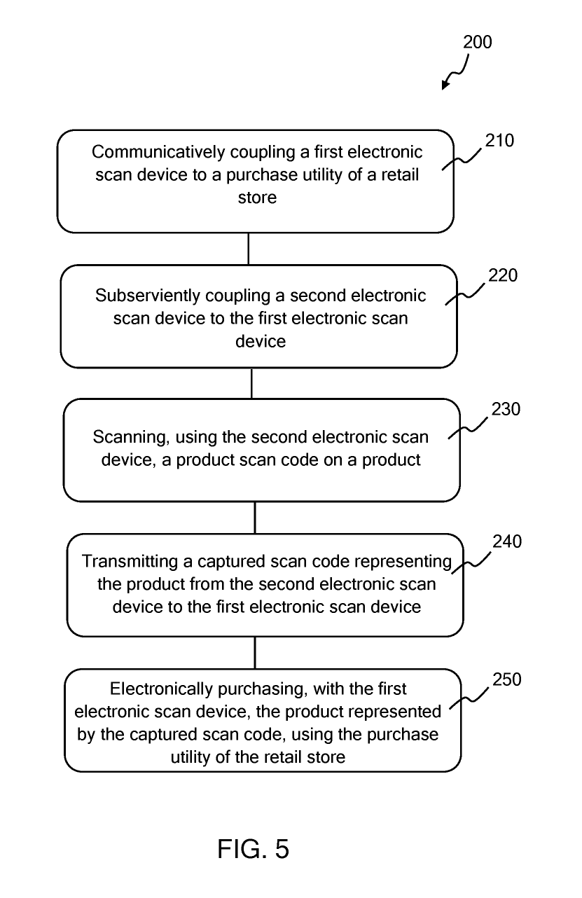

FIG. 5 illustrates a method 200 of purchasing a product. Method 200 includes an act 210 of communicatively coupling a first electronic scan device to a purchase utility of a retail store. The first electronic scan device can be any mobile computing device capable of reading a product scan code such as a bar code, a QR code, or any other symbol which tells the electronic scan device what product is being proposed for purchase. Communicatively coupling can include wired or wireless communication of any type. The purchase utility can be software or hardware based and stored on a store server, for example. The purchase utility can be any software or hardware based element that can execute an electronic purchase of items for a customer or user of the purchase utility.

Method 200 also includes an act 220 of subserviently coupling a second electronic scan device to the first electronic scan device. Subserviently coupling means coupling the second electronic scan device to the first electronic scan device such that the first electronic scan device becomes a master device and the second electronic scan device is the slave device. The master device controls purchasing and gaming activities of the slave device, and the slave device no longer is allowed to purchase items through the retail store purchase utility. Subserviently coupling the second electronic scan device to the first electronic scan device can take many forms. In some embodiments, subserviently coupling includes scanning, with the first electronic scan device, a linking symbol displayed on a display of the second electronic scan device. The linking symbol can be a bar code, a quick response (QR) code, an alphanumeric number, or some other symbol, image, or logo. The linking symbol can be displayed on an electronic display of the second electronic scan device or be printed, stamped, or otherwise attached to the second electronic scan device. In some embodiments, subserviently coupling includes scanning, with the second electronic scan device, a linking symbol displayed on a display of the first electronic scan device. In some embodiments, subserviently coupling includes scanning, with the first electronic scan device, a linking symbol displayed on a display of the second electronic scan device and also scanning, with the second electronic scan device, a linking symbol displayed on a display of the first electronic scan device.

In some embodiments, method 200 includes transmitting, by the first electronic scan device, a second electronic scan device notice of subservient status to the retail store purchase utility. The second electronic scan device notice of subservient status tells the retail store purchase utility that the second electronic scan device has been subserviently coupled to another electronic scan device, and that the purchase utility should deny any purchase requests that come from the second electronic scan device—in other words the purchase utility should disable access to the purchase utility by the second electronic scan device. In some embodiments, the second electronic scan device notice of subservient status is transmitted by the second electronic scan device to the retail store purchase utility.

Method 200 also includes an act 230 of scanning, using the second electronic scan device, a product scan code on a product. The product scan code can be any bar code, QR code, or other image or symbol that represents the product to be purchased. Once second electronic scan device is subserviently coupled to the first electronic scan device, second electronic scan device can be used to select a product for purchase by scanning the product scan code on the product. This scan of the product scan code creates an electronically stored captured scan code representing the product. The purchase of the product does not proceed, however, until the purchase is approved by the first electronic scan device.

Method 200 also includes an act 240 of transmitting a captured scan code representing the product from the second electronic scan device to the first electronic scan device. The second electronic scan device sends the captured scan code to the first electronic scan device for approval of purchase of the product from the user of the first electronic scan device. If the second electronic scan device sends the captured scan code to the purchase utility and attempts a purchase of the product, the purchase utility will reject the purchase request from the second electronic scan device because the purchase utility knows the second electronic scan device is in slave mode, being subserviently coupled to another electronic scan device (in this example, the first electronic scan device). In some embodiment, method 200 includes transmitting an electronic purchase request for the first product from the second electronic scan device to the first electronic scan device.

Method 200 also includes an act 250 of electronically purchasing, with the first electronic scan device, the product represented by the captured scan code, using the purchase utility of the retail store. In some embodiments, method 200 includes requesting purchase instructions regarding the product represented by the product scan code from the user of the first electronic scan device. In some embodiments, method 200 includes receiving, by the first electronic scan device, a purchase approval indicator for the product represented by the captured scan code received from the second electronic scan device. In some embodiments, electronically purchasing is executed in response to the first electronic scan device receiving the purchase approval indicator for the product. Once the first electronic scan device receives the captured scan code from the second electronic scan device, it querys the user of the first electronic scan device as to whether the purchase of the product represented by the captured scan code is approved or not. If the purchase is denied, no purchase is initiated and the product is returned to the shelf. If the first electronic scan device receives an indication from the user of the first electronic scan device that the purchase of the product is approved, the first electronic scan device proceeds with the purchase of the product. In some embodiments, the first electronic scan device puts the captured scan code in an electronic shopping cart (a memory location, for example) and does not complete the purchase with the purchase utility until the use of the first electronic scan device indicates that all desired items are in the shopping cart and purchase may continue. In some embodiments, the first electronic scan device proceeds to individually purchase the product represented by the captured scan code using the purchase utility of the retail store. In some embodiments, the first electronic scan device purchases the product in response to verifying that the product is on a shopping list stored in the first electronic scan device or in the retail store purchase utility. In some embodiments, the first electronic scan device denies a purchase of the product in response to verifying that the product is not on a shopping list stored in the first electronic scan device or in the retail store purchase utility. In some embodiments, the first electronic scan device denies a purchase of the product in response to verifying that the product is a restricted product.

The second electronic scan device can participate in gaming as well as purchasing activities through the first electronic scan device. In some embodiments, method 200 includes awarding a game point to the second electronic scan device in response to the first electronic scan device receiving the purchase approval indicator. The first electronic scan device can give a game point to the second electronic scan device for any captured scan codes that are received and approved for purchase, for example. The user of the second electronic scan device can compete with the user of other subservient electronic scan devices for total points, for example, or in other games.

In some embodiments, method 200 includes tracking, by the first electronic scan device, a plurality of second electronic device game points awarded to the second electronic scan device. The first electronic scan device can track the total number of game point awarded to the second electronic scan device and other electronic scan devices subserviently coupled to the first electronic scan device. In some embodiments, method 200 includes reporting, by the first electronic scan device to a gaming utility of the retail store, the plurality of second electronic device game points awarded to the second electronic scan device. A gaming utility of the retail store can track total points awarded to users and players of the games. The gaming utility can be a software or hardware based element that is on a server with the purchase utility, for example, or is resident in or on a different system. The gaming utility can use the total number of game points for gaming purposes or for customer development purposes. The gaming utility can provide loyalty points to users according to game points received, for example. The gaming utility can display high scores in the store, for example, so that kids playing the game and helping their parents shop can compete against each other for high scores.

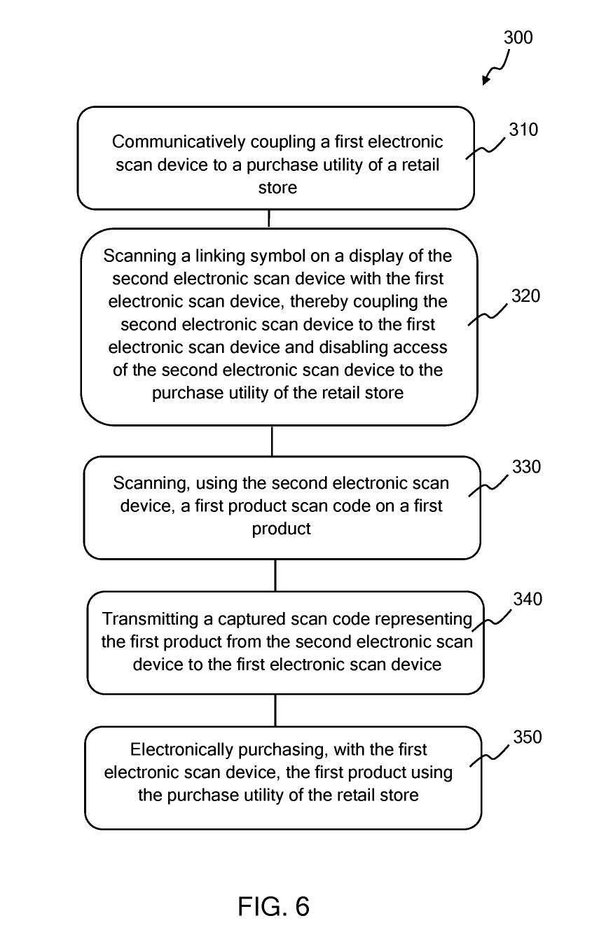

FIG. 6 illustrates a method 300 of purchasing a product. Method 300 includes an act 310 of communicatively coupling a first electronic scan device to a purchase utility of a retail store. The first electronic scan device can be any mobile computing device capable of reading a product scan code such as a bar code, a QR code, or any other symbol which tells the electronic scan device what product is being proposed for purchase. Communicatively coupling can include wired or wireless communication of any type. The purchase utility can be software or hardware based and stored on a store server, for example. The purchase utility can be any software or hardware based element that can execute an electronic purchase of items for a customer or user of the purchase utility.

Method 300 also includes an act 320 of scanning a linking symbol on a display of a second electronic scan device with the first electronic scan device, thereby coupling the second electronic scan device to the first electronic scan device and disabling access of the second electronic scan device to the purchase utility of the retail store. Scanning the linking symbol on the display of the second electronic scan device with the first electronic scan device is a way of subserviently coupling the second electronic scan device to the first electronic scan device. Subserviently coupling means coupling the second electronic scan device to the first electronic scan device such that the first electronic scan device becomes a master device and the second electronic scan device is the slave device. The master device controls purchasing and gaming activities of the slave device, and the slave device no longer is disable from purchasing items through the retail store purchase utility. Subserviently coupling the second electronic scan device to the first electronic scan device can take many forms. In this specific embodiment, subserviently coupling includes scanning, with the first electronic scan device, a linking symbol displayed on a display of the second electronic scan device. The linking symbol can be a bar code, a quick response (QR) code, an alphanumeric number, or some other symbol, image, or logo. The linking symbol can be displayed on an electronic display of the second electronic scan device or be printed, stamped, or otherwise attached to the second electronic scan device. In other embodiments, subserviently coupling includes scanning, with the second electronic scan device, a linking symbol displayed on a display of the first electronic scan device. In some embodiments, subserviently coupling includes scanning, with the first electronic scan device, a linking symbol displayed on a display of the second electronic scan device and also scanning, with the second electronic scan device, a linking symbol displayed on a display of the first electronic scan device.

In some embodiments, method 300 includes transmitting, by the first electronic scan device, a second electronic scan device notice of subservient status to the retail store purchase utility. The second electronic scan device notice of subservient status tells the retail store purchase utility that the second electronic scan device has been subserviently coupled to another electronic scan device, and that the purchase utility should deny any purchase requests that come from the second electronic scan device—in other words the purchase utility should disable access to the purchase utility by the second electronic scan device. The purchase utility disables the access of the second electronic scan device to the purchase utility of the retail store in response to receiving the second electronic scan device notice of subservient status. In some embodiments, the second electronic scan device notice of subservient status is transmitted by the second electronic scan device to the retail store purchase utility.

Method 300 includes an act 330 of scanning, using the second electronic scan device, a first product scan code on a first product. The product scan code can be any bar code, QR code, or other image or symbol that represents the product to be purchased. Once second electronic scan device is subserviently coupled to the first electronic scan device, second electronic scan device can be used to select a product for purchase by scanning the product scan code on the product. This scan of the product scan code creates an electronically stored captured scan code representing the product.

Method 300 includes an act 340 of transmitting a captured scan code representing the first product from the second electronic scan device to the first electronic scan device. The second electronic scan device sends the captured scan code to the first electronic scan device for approval of purchase of the product from the user of the first electronic scan device. If the second electronic scan device sends the captured scan code to the purchase utility and attempts a purchase of the product, the purchase utility will reject the purchase request from the second electronic scan device because the purchase utility knows the second electronic scan device is in slave mode, being subserviently coupled to another electronic scan device (in this example, the first electronic scan device). In some embodiment, method 200 includes transmitting an electronic purchase request for the first product from the second electronic scan device to the first electronic scan device.

Method 300 includes an act 350 of electronically purchasing, with the first electronic scan device, the first product using the purchase utility of the retail store. In some embodiments, the electronically purchasing is executed in response to the first electronic scan device receiving a purchase approval indicator for the first product. In some embodiments, method 300 includes requesting purchase instructions regarding the first product represented by the product scan code from the user of the first electronic scan device. In some embodiments, method 300 includes receiving, by the first electronic scan device, a purchase approval indicator for the first product represented by the captured scan code received from the second electronic scan device. In some embodiments, electronically purchasing is executed in response to the first electronic scan device receiving the purchase approval indicator for the first product. Once the first electronic scan device receives the captured scan code from the second electronic scan device, it querys the user of the first electronic scan device as to whether the purchase of the first product represented by the captured scan code is approved or not. If the purchase is denied, no purchase is initiated and the first product is returned to the shelf. If the first electronic scan device receives an indication from the user of the first electronic scan device that the purchase of the first product is approved, the first electronic scan device proceeds with the purchase of the product.

In some embodiments, the first electronic scan device puts the captured scan code in an electronic shopping cart (a memory location, for example) and does not complete the purchase with the purchase utility until the use of the first electronic scan device indicates that all desired items are in the shopping cart and purchase may continue. In some embodiments, the first electronic scan device proceeds to individually purchase the first product represented by the captured scan code using the purchase utility of the retail store.

In some embodiments, the electronically purchasing is executed in response to the first electronic scan device determining that the first product is on a shopping list stored in the first electronic scan device. In this embodiment, the first electronic scan device purchases the first product in response to verifying that the product is on a shopping list. The shopping list can be stored in the first electronic scan device or in the retail store purchase utility. In some embodiments, the first electronic scan device denies a purchase of the product in response to verifying that the product is not on a shopping list stored in the first electronic scan device or in the retail store purchase utility. In some embodiments, the first electronic scan device denies a purchase of the product in response to verifying that the product is a restricted product.

In some embodiments, method 300 includes scanning, using the second electronic scan device, a second product scan code on a second product. In some embodiments, method 300 includes transmitting a captured scan code representing the second product from the second electronic scan device to the first electronic scan device. In some embodiments, method 300 includes rejecting a purchase of the second product, with the first electronic scan device, in response to the second product not being on the shopping list.

In some embodiments, method 300 includes rejecting a purchase of the second product, with the first electronic scan device, in response to the second product being a restricted product.

In some embodiments, method 300 includes communicatively coupling the first electronic scan device to a gaming utility of the retail store. In some embodiments, method 300 includes awarding a second electronic scan device game point to the second electronic scan device in response to the first electronic scan device electronically purchasing the first product. In some embodiments, method 300 includes comprising tracking, by the first electronic scan device, a plurality of second electronic scan device game points awarded to the second electronic scan device. In some embodiments, method 300 includes reporting, by the first electronic scan device to the gaming utility of the retail store, the plurality of second electronic scan device game points awarded to the second electronic scan device.

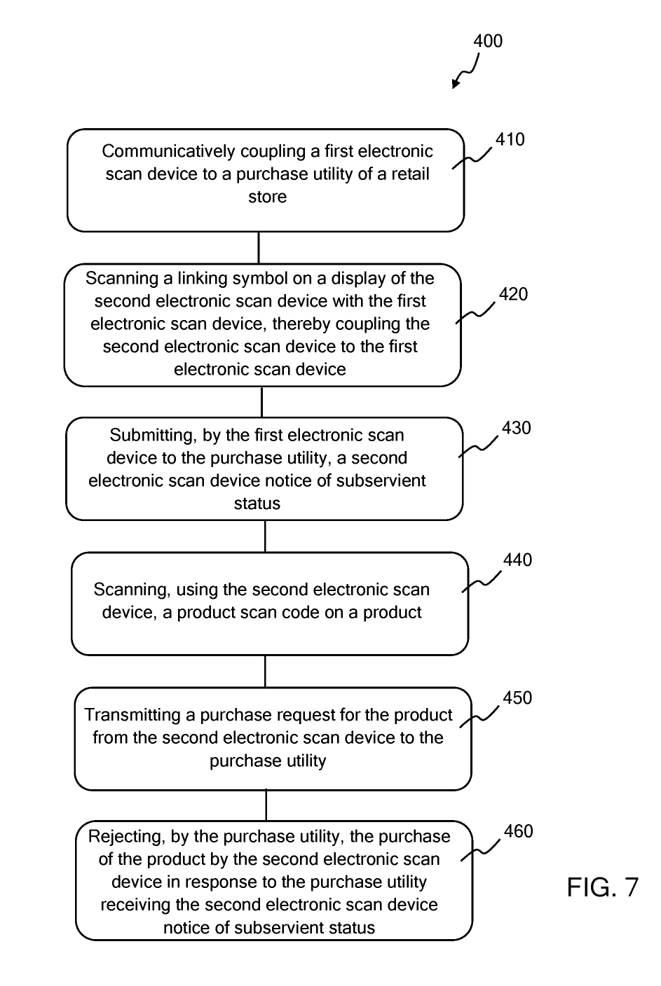

FIG. 7 illustrates a method 400 of electronically submitting a purchase request using an electronic scan device. Method 400 includes an act 410 of communicatively coupling a first electronic scan device to a purchase utility of a retail store. The first electronic scan device can be any mobile computing device capable of reading a product scan code such as a bar code, a QR code, or any other symbol which tells the electronic scan device what product is being proposed for purchase. Communicatively coupling can include wired or wireless communication of any type. The purchase utility can be software or hardware based and stored on a store server, for example. The purchase utility can be any software or hardware based element that can execute an electronic purchase of items for a customer or user of the purchase utility.

Method 400 also includes an act 420 of scanning a linking symbol on a display of a second electronic scan device with the first electronic scan device, thereby communicatively coupling the second electronic scan device to the first electronic scan device. Scanning the linking symbol on the display of the second electronic scan device with the first electronic scan device is a way of subserviently coupling the second electronic scan device to the first electronic scan device. Subserviently coupling means coupling the second electronic scan device to the first electronic scan device such that the first electronic scan device becomes a master device and the second electronic scan device is the slave device. The master device controls purchasing and gaming activities of the slave device, and the slave device no longer is disable from purchasing items through the retail store purchase utility. Subserviently coupling the second electronic scan device to the first electronic scan device can take many forms. In this specific embodiment, subserviently coupling includes scanning, with the first electronic scan device, a linking symbol displayed on a display of the second electronic scan device. The linking symbol can be a bar code, a quick response (QR) code, an alphanumeric number, or some other symbol, image, or logo. The linking symbol can be displayed on an electronic display of the second electronic scan device or be printed, stamped, or otherwise attached to the second electronic scan device. In other embodiments, subserviently coupling includes scanning, with the second electronic scan device, a linking symbol displayed on a display of the first electronic scan device. In some embodiments, subserviently coupling includes scanning, with the first electronic scan device, a linking symbol displayed on a display of the second electronic scan device and also scanning, with the second electronic scan device, a linking symbol displayed on a display of the first electronic scan device.

Method 400 includes an act 430 of transmitting, by the first electronic scan device, a second electronic scan device notice of subservient status to the retail store purchase utility in response to the scan by the first electronic scan device of the linking symbol on the display of the second electronic scan device. The second electronic scan device notice of subservient status tells the retail store purchase utility that the second electronic scan device has been subserviently coupled to another electronic scan device, and that the purchase utility should deny any purchase requests that come from the second electronic scan device—in other words the purchase utility should disable access to the purchase utility by the second electronic scan device. The purchase utility disables the access of the second electronic scan device to the purchase utility of the retail store in response to receiving the second electronic scan device notice of subservient status. In some embodiments, the second electronic scan device notice of subservient status is transmitted by the second electronic scan device to the retail store purchase utility.

Method 400 includes an act 440 of scanning, using the second electronic scan device, a product scan code on a product. The product scan code can be any bar code, QR code, or other image or symbol that represents the product to be purchased. Once second electronic scan device is subserviently coupled to the first electronic scan device, second electronic scan device can be used to select a product for purchase by scanning the product scan code on the product. This scan of the product scan code creates an electronically stored captured scan code representing the product.

Method 400 includes an act 450 of transmitting an electronic purchase request for the product from the second electronic scan device to the purchase utility. In some embodiments, the second electronic scan device sends a captured scan code with the electronic purchase request.

Method 400 includes an act 460 of rejecting, by the purchase utility, the purchase of the product by the second electronic scan device in response to the purchase utility receiving the second electronic scan device notice of subservient status. The second electronic scan device has been made a slave device, and so its purchasing ability through the retail store purchase utility is disabled. The second electronic scan device must send its purchase requests through the first electronic scan device.

Method 400 can include many other acts. In some embodiments, method 400 includes transmitting the purchase request for the product from the second electronic scan device to the first electronic scan device. This is how the second electronic scan device must purchase products, by going through the first electronic scan device.

In some embodiments, method 400 includes electronically purchasing, with the first electronic scan device, the product using the purchase utility of the retail store. Once the second electronic scan device goes through the first electronic scan device for a purchase and the first electronic scan device approves the purchase, the first electronic scan device electronically purchases the product through the retail store purchase utility. In some embodiments, method 400 includes verifying, by the first electronic scan device, that the product is listed on a shopping list stored in the first electronic scan device. If the product is listed on the shopping list, the first electronic scan device will purchase the product. In some embodiments, the first electronic scan device denies the purchase of the product because the product is a restricted product. The produce can be classified as restricted either by its bar code identifying it as a restricted product such as alcohol or tobacco, or by the first electronic scan device having a list of restricted items created by the user of the first electronic scan device.

A retail store electronic scanning purchase and gaming system has been described. The electronic scanning purchase and gaming system provides a way for parents to include their children in the shopping experience. Parents can give their children electronic scanners to use to participate in games and to purchase items, without being concerned that the electronic scanners the children have can complete purchases of products. The parents will first make the electronic scanners they give to their children slave devices to their own electronic scanner by subserviently coupling the children's electronic scanners to the parent's electronic scanner. Subsequent to subservient coupling, all purchase activities will be routed through the parent's electronic scanner for approval. Subserviently coupling is accomplished by using one of the electronic scan devices to scan a linking symbol on another electronic scan device. The children can use their electronic scanners to participate in games, as well as to find and scan products for purchase for the parents. This will keep children engaged in shopping activities and help the parents get their shopping done.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A method of purchasing a product, the method comprising:
communicatively coupling a first electronic scan device to a purchase utility of a retail store;
scanning a linking symbol on a display of a second electronic scan device with the first electronic scan device, thereby coupling the second electronic scan device to the first electronic scan device and disabling access of the second electronic scan device to the purchase utility of the retail store;
scanning, using the second electronic scan device, a first product scan code on a first product;
transmitting a captured scan code representing the first product from the second electronic scan device to the first electronic scan device; and
electronically purchasing, with the first electronic scan device, the first product using the purchase utility of the retail store.

2. The method of claim 1, wherein the electronically purchasing is executed in response to the first electronic scan device receiving a purchase approval indicator for the first product.

3. The method of claim 1, wherein the electronically purchasing is executed in response to the first electronic scan device determining that the first product is on a shopping list stored in the first electronic scan device.

4. The method of claim 1, further comprising:
communicatively coupling the first electronic scan device to a gaming utility of the retail store; and
awarding a second electronic scan device game point to the second electronic scan device in response to the first electronic scan device electronically purchasing the first product.

5. The method of claim 4, further comprising tracking, by the first electronic scan device, a plurality of second electronic scan device game points awarded to the second electronic scan device.

6. The method of claim 5, further comprising reporting, by the first electronic scan device to the gaming utility of the retail store, the plurality of second electronic scan device game points awarded to the second electronic scan device.

7. The method of claim 1, further comprising sending a second electronic scan device notice of subservient status from the first electronic scan device to the purchase utility, wherein the purchase utility disables the access of the second electronic scan device to the purchase utility of the retail store in response to receiving the second electronic scan device notice of subservient status.

8. The method of claim 3, further comprising:
scanning, using the second electronic scan device, a second product scan code on a second product;
transmitting a captured scan code representing the second product from the second electronic scan device to the first electronic scan device; and
rejecting a purchase of the second product, with the first electronic scan device, in response to the second product not being on the shopping list.

9. The method of claim 1, further comprising:
scanning, using the second electronic scan device, a second product scan code on a second product;
transmitting a captured scan code representing the second product from the second electronic scan device to the first electronic scan device; and
rejecting a purchase of the second product, with the first electronic scan device, in response to the second product being a restricted product.

10. A retail store scanning game and purchase system comprising:
a retail store purchase utility;
a retail store gaming utility;
a first electronic scan device, wherein the retail store purchase utility accepts a first electronic purchase request for a first product from the first electronic scan device;
and
a second electronic scan device communicatively coupled to the first electronic scan device, wherein a scan by the first electronic scan device of a linking symbol on a display of the second electronic scan device disables access of the second electronic scan device to the retail store purchase utility.

11. The retail store scanning game and purchase system of claim 10, wherein the first electronic scan device submits a second electronic scan device notice of subservient status to the retail store purchase utility in response to the scan by the first electronic scan device of the linking symbol on the display of the second electronic scan device.

12. The retail store scanning game and purchase system of claim 11, wherein the first electronic scan device transmits the first electronic purchase request for the first product to the retail store purchase utility in response to:
receiving the first electronic purchase request for the first product from the second electronic scan device; and
verifying that the first product is listed on a shopping list stored in the first electronic scan device.

13. The retail store scanning game and purchase system of claim 11, wherein the first electronic scan device transmits the first electronic purchase request for the first product to the retail store purchase utility in response to:
receiving the first electronic purchase request for the first product from the second electronic scan device; and
receiving a purchase approval indicator for the first product from a user of the first electronic scan device.

14. The retail store scanning game and purchase system of claim 12, wherein the first electronic scan device rejects a second electronic purchase request for a second product from the second electronic scan device in response to determining that the second product is not listed on the shopping list stored in the first electronic device.

15. The retail store scanning game and purchase system of claim 12, wherein the first electronic scan device rejects a second electronic purchase request for a second product from the second electronic scan device in response to determining that the second product is a restricted product.

16. The retail store scanning game and purchase system of claim 12, wherein the first electronic scan device awards a second electronic scan device game point to the second electronic scan device in response to:
receiving the first electronic purchase request for the first product from the second electronic scan device; and
verifying that the first product is listed on the shopping list stored in the first electronic scan device.

17. The retail store scanning game and purchase system of claim 16, wherein the first electronic scan device reports, to the retail store gaming utility, a total number of second electronic scan device game points awarded to the second electronic scan device.

18. A method of electronically submitting a purchase request using an electronic scan device, the method comprising:
communicatively coupling a first electronic scan device to a purchase utility of a retail store;
scanning a linking symbol on a display of a second electronic scan device with the first electronic scan device, thereby communicatively coupling the second electronic scan device to the first electronic scan device;
submitting, by the first electronic scan device to the purchase utility, a second electronic scan device notice of subservient status in response to the scan by the first electronic scan device of the linking symbol on the display of the second electronic scan device;
scanning, using the second electronic scan device, a product scan code on a product;
transmitting a purchase request for the product from the second electronic scan device to the purchase utility; and
rejecting, by the purchase utility, the purchase of the product by the second electronic scan device in response to the purchase utility receiving the second electronic scan device notice of subservient status.

19. The method of claim 18, further comprising:
transmitting the purchase request for the product from the second electronic scan device to the first electronic scan device; and
electronically purchasing, with the first electronic scan device, the product using the purchase utility of the retail store.

20. The method of claim 18, further comprising verifying, by the first electronic scan device, that the product is listed on a shopping list stored in the first electronic scan device.
